(19) United States
(12) Patent Application Publication
(10) Pub. No.: US 2014/0138116 A1
(43) Pub. Date: May 22, 2014

(54) Adjustable Length Cabling Systems

(71) Applicants: Paul C. Burke, Lake Forest, IL (US); Mark Holmes, Round Lake Beach, IL (US); John A. Runzel, Elgin, IL (US)

(72) Inventors: Paul C. Burke, Lake Forest, IL (US); Mark Holmes, Round Lake Beach, IL (US); John A. Runzel, Elgin, IL (US)

(21) Appl. No.: 14/162,373

(22) Filed: Jan. 23, 2014

Related U.S. Application Data
(62) Division of application No. 10/599,359, filed on May 29, 2007.

(51) Int. Cl. B60R 16/02; H02G 1/06

(52) U.S. Cl. CPC B60R 16/02; H02G 1/06
USPC 174/69; 29/428

(57) ABSTRACT

Adjustable length cabling systems are disclosed. A disclosed cabling system for use with a passenger vehicle having a plurality of rows of passenger seats includes a multi-conductor cable having a length and first and second ends having respective first and second connectors coupled thereto. The multi-conductor cable is configured to convey electrical signals to at least one of the rows of seats. The disclosed cabling system also includes a cable storage unit configured to hold a coiled portion of the length of the multi-conductor cable. The cable storage unit has a housing portion configured to be mounted underneath at least one of the passenger seats.

### RELATED APPLICATION

This application claims the benefit of the filing date of U.S. Provisional Patent Application No. 60/556,666, filed on Mar. 26, 2004, the entire disclosure of which is incorporated by reference herein.

### FIELD OF THE DISCLOSURE

The present disclosure relates generally to cabling and, more particularly, to adjustable length cable systems.

### BACKGROUND

Seating arrangements associated with transportation such as, for example, busses, trains, aircraft, etc. typically provide multiple rows of seats for passengers. Each row may include one or more adjacent seats, which may be joined via a mounting rail assembly, base unit, or any other suitable frame or structure that facilitates attachment of the seats to the transport. In addition, the rows of seats are typically arranged to provide a walkway or aisle, which is often located along the longitudinal axis of the transport. Thus, rows of seats may be disposed on each side and along the length of such an aisle or walkway.

In the case of modern commercial aircraft, passenger seats typically provide a variety of electronic functions that require power signals, communication signals, etc. In particular, as is well known, aircraft passenger seats typically provide access to in-flight entertainment such as audio programming, video programming, etc., communication systems such as, for example, telephone service, etc. To convey the electrical signals needed to all of the passenger seats, fixed length cables or wiring harnesses electrically couple one row of seats to a next row of seats. In this manner, rows of passenger seats may be daisy-chained together with these fixed length cables or wiring harnesses to provide electrical power signals, communication signals, etc. to all of the seats.

In some transports, particularly in commercial aircraft, it is often desirable to change the distance between the rows of seats to configure the aircraft for a different flight routing or purpose. Unfortunately, because the rows of seats are often electrically coupled to each other using fixed length cables, a change (e.g., an increase) in seat row spacing typically requires replacement of the existing fixed length cables with fixed length cables having an appropriate length. Of course, changing seat-to-seat cabling is a time consuming and expensive process. In addition, many aircraft manufacturers and commercial airline companies do not maintain a sufficient or complete stock (or in some cases any stock) of different length cable assemblies. As a result, the relatively long lead times associated with cable assemblies make a relatively quick change in seat spacing impractical.

The use of fixed length seat-to-seat cabling is further complicated by the fact that spacing between seat rows is typically not consistent for all rows along the length of the aircraft. Specifically, the large numbers and variety of electrical and mechanical sub-systems that are distributed throughout an aircraft often require a particular row of seats to be located slightly closer or slightly further from another row of seats to prevent, for example, mechanical interference between one or more seats an one or more of these sub-systems.

Additionally, the above-mentioned fixed length cable assemblies used in connection with aircraft must comply with stringent temperature and other environmental requirements. Unfortunately, known cables compliant with these requirements typically utilize a relatively large amount of insulation for each of a plurality of the multiple conductors making up the cable as well as a relatively thick (and stiff) outer jacket. Such large amounts of insulation result in a relatively high stiffness and weight per unit length, which are undesirable characteristics, particularly for seat-to-seat cabling applications in commercial aircraft.

### BRIEF DESCRIPTION OF THE DRAWINGS

FIG. 1 depicts a row of aircraft seats.

FIG. 2 depicts a known manner in which fixed length cable assemblies are used to provide power, data and other signals to aircraft seats and to electrically couple one row of seats to another.

FIG. 3 depicts an example adjustable length cable system.

FIG. 4 depicts another example adjustable length cable system.

FIG. 5 depicts an example manner in which the adjustable length cable systems of FIGS. 3 and 4 may be used to couple signals between aircraft seats.

FIG. 6 is a detailed depiction of one manner in which the cabling used in the examples of FIGS. 3 and 4 may be implemented.

FIG. 7 is a detailed depiction of one manner in which the Ethernet cable shown in FIG. 6 may be implemented.

### DETAILED DESCRIPTION

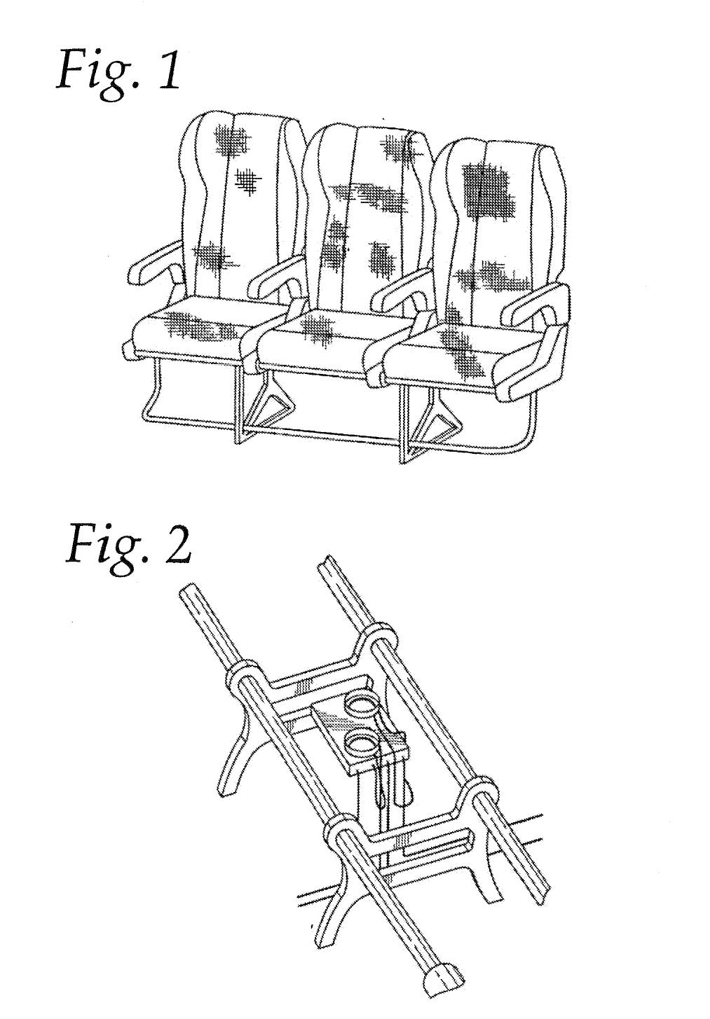

FIG. 1 depicts a row of aircraft seats. While the row of seats depicted in FIG. 1 shows three adjacent seats, any other number of seats could be used instead. Further, it should be understood that while the example adjustable cable systems described herein are described as being used in connection with aircraft seats, the example adjustable cables systems are more generally applicable. For example, the adjustable cable systems described herein may be used in connection with any other types of seats. Still further, the adjustable cable systems described herein may be used in any other applications desired.

FIG. 2 depicts a known manner in which fixed length cable assemblies are used to provide power, data and other signals to aircraft seats and to electrically couple one row of seats to another. As shown in FIG. 2, cables having extra length are used to enable the rows of seats to be moved apart without having to replace the cable assemblies. However, as depicted in FIG. 2, the extra length of cabling is loosely placed underneath the seat and, as a result, presents a potential hazard and/or failure if the excess cabling is dislodged and falls onto the floor underneath the seat.

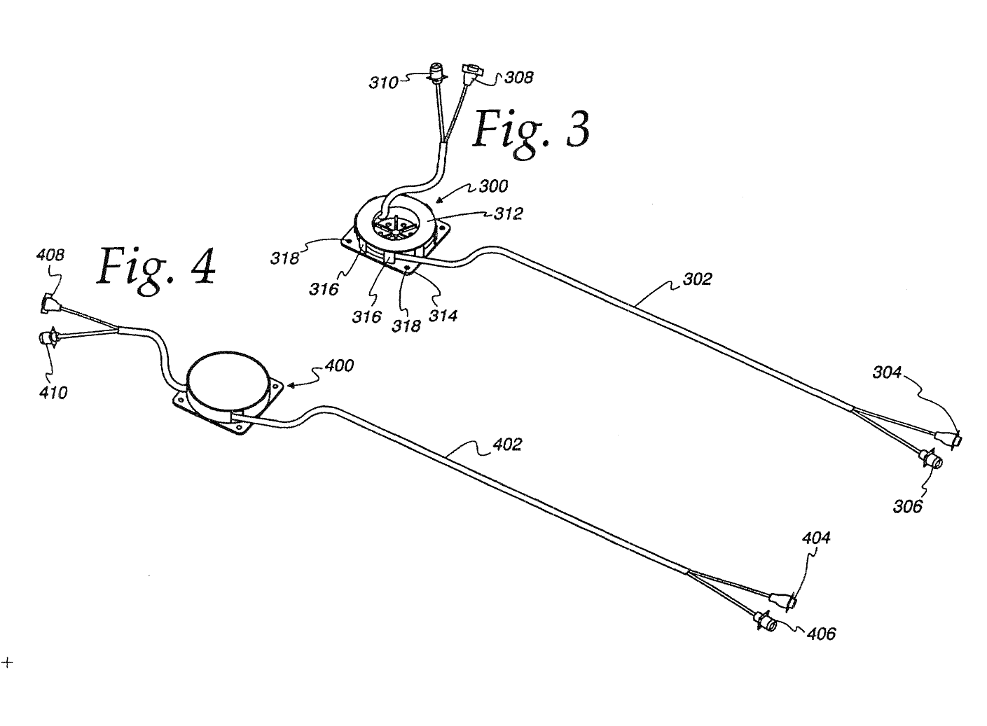

FIG. 3 depicts an example adjustable length cable system. The example system depicted in FIG. 3 includes a cable storage unit 300 and a cable assembly 302 having connectors or terminations 304, 306, 308 and 310. The cable storage unit 300 includes a spool or reel 312 upon which a portion of the length of the cable assembly 302 is wound. The cable storage unit 300 also includes a base or housing 314. The housing 314 includes a plurality of circumferentially spaced tabs 316 configured to enable the reel 312 to be rotatable relative to the housing 314. Additionally, the tabs 316 may be further configured to retain the wound portion of the cable assembly 302 against the reel 312. The housing 314 may also provide mounting holes 318 to facilitate mounting of the cable storage unit 300 underneath a seat, or in some other location. The connectors 304, 306, 308 and 310 may include any desired combination of DIN connectors, RCA connectors, or any other types of electrical connectors.

In operation, the effective length of the adjustable cabling system shown in FIG. 3 may be changed by rotating the reel 312 relative to the housing 314. In the example of FIG. 3, rotating the reel 312 clockwise reduces the effective (e.g., overall) length of the cabling system and rotating the reel 312 counter-clockwise increases the effective length of the cabling system.

FIG. 4 depicts another example adjustable length cable system. Similar to the example adjustable cabling system depicted in FIG. 3, the example adjustable cabling system of FIG. 4 includes a cable storage unit 400 and a cable assembly 402 having connectors or terminations 404, 406, 408 and 410. In contrast to the example system of FIG. 3, the cable storage unit 400 depicted in FIG. 4 does not include a reel or spool to enable rotatable retraction and/or extension of a length of the cable assembly. Instead, the storage unit 400 provides an internal chamber into which additional length of the cable assembly 402 may be disposed (e.g., by manually pushing a length of the cable assembly 402 into the chamber) and/or extracted (e.g., again by manually pulling a length of the cable assembly 402 from the chamber).

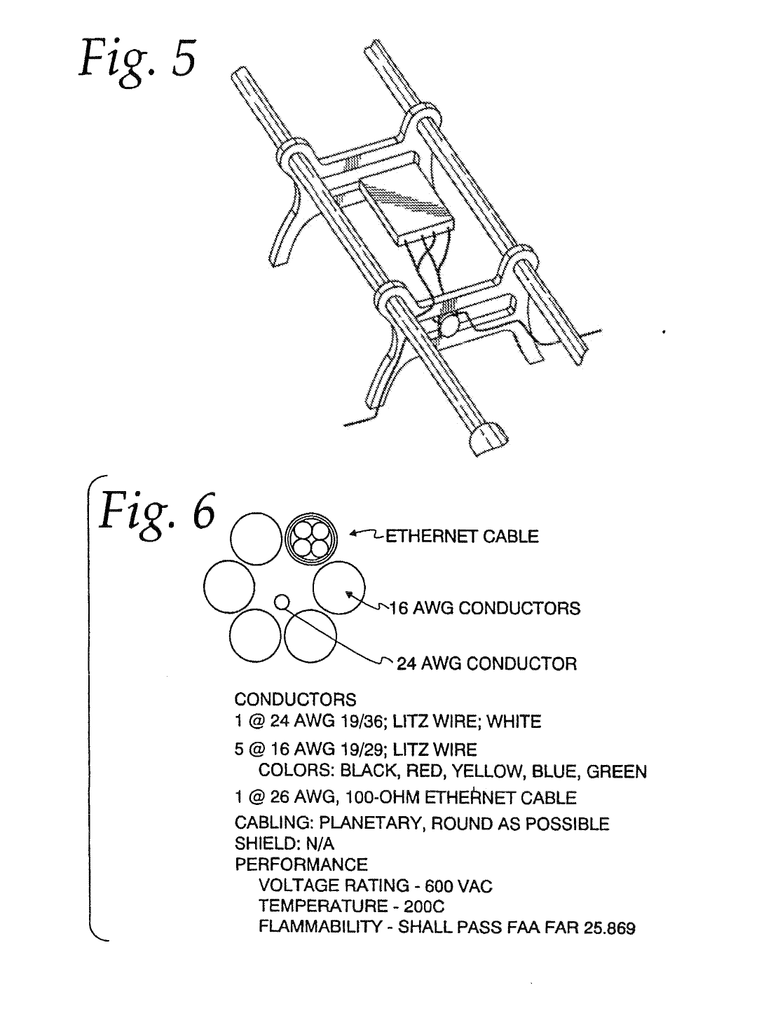

FIG. 5 depicts an example manner in which the adjustable length cable systems of FIGS. 3 and 4 may be used to couple signals between aircraft seats. As shown in the example implementation of FIG. 5, the adjustable length cable systems described herein may be used to eliminate loose lengths of cable (e.g., as depicted in FIG. 2) that facilitate changes in the distances between rows of seats (e.g., in aircraft). As can be seen in the example of FIG. 5, in contrast to known fixed length cable assemblies, the adjustable length cabling systems described herein enable a single type of cabling system to be used to electrically couple power, data and other signals to multiple rows of seats within, for example, aircraft and/or other transports. Further, with the example adjustable length cabling systems described herein, changes in distances between seats can be carried out without having to engage in the costly process of designing, obtaining and installing different fixed length cables.

FIG. 6 is a detailed depiction of one manner in which the cabling used in the examples of FIGS. 3 and 4 may be implemented. As depicted in the example implementation of FIG. 6, the cabling may be a multi-conductor cable 600 configured to convey various power, data (e.g., Ethernet), and other electrical signals in conformance with commercial aircraft requirements. To reduce weight, and in contrast to prior aircraft cabin cabling, the example cabling of FIG. 6 utilizes Litz wire, which meets the voltage (e.g., 600 VAC), temperature (e.g., 200° C.) and flammability requirements (e.g., FAA FAR 25.869) of commercial aircraft. However, other specifications may be met as well. As is known, Litz wire is constructed of individual film insulated wires bunched or braided together in a uniform pattern of twists and length of lay. In addition, the outer jacket (not shown) surrounding the multi-conductor cable 600 depicted in FIG. 6 may be a high temperature braided fabric that provides a high degree of mechanical flexibility, is lightweight, and meets the stringent environmental requirements of commercial aircraft. The example multi-conductor cable 600 of FIG. 6 includes an Ethernet cable (e.g., a 26 AWG 100 ohm cable) 602, five Litz wire conductors (e.g., 16 AWG 19/29), one of which is shown at reference number 604, and a single smaller gauge (e.g., 24 AWG, 19/36) Litz wire conductor 606.

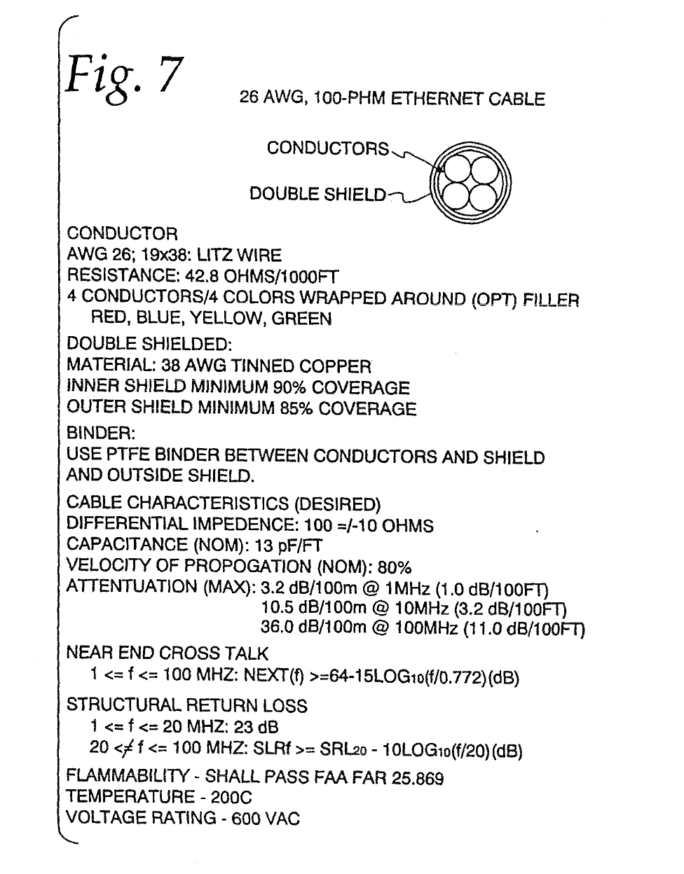

FIG. 7 is a detailed depiction of one manner in which the Ethernet cable 602 shown in FIG. 7 may be implemented. As depicted in FIG. 7, the example Ethernet cable 602 is fabricated using Litz wire (e.g., 26 AWG, 19/38) to minimize weight, maximize mechanical flexibility while meeting the environmental requirements associated with commercial aircraft. The example Ethernet cable 602 includes four conductors (one of which is shown at reference number 700), which may be wrapped around an optional filler (not shown). In addition, the example cable 602 includes a double shield 704 and may include a PTFE binder between the conductors 700, the shield 704, and the outside of the shield 704. Using the example cabling construction depicted in FIGS. 6 and 7, a seventy-five inch long cable may weigh approximately 0.73 pounds. In contrast, known fixed length cables for use in commercial aircraft seat-to-seat cabling having a length of about 47 inches may weigh more than 0.85 pounds.

Although certain methods, apparatus, and articles of manufacture have been described herein, the scope of coverage of this patent is not limited thereto. On the contrary, this patent covers all apparatus, methods, and articles of manufacture fairly falling within the scope of the appended claims either literally or under the doctrine of equivalents.

We claim:

1. (canceled)

2. (canceled)

3. (canceled)

4. (canceled)

5. (canceled)

6. (canceled)

7. (canceled)

8. (canceled)

9. A cable routing system for an aircraft, the cable routing system comprising:
a cable housing configured to be secured to a first row of seats;
a cable extending from the cable housing to a second location that is distal from the first row of seats;
wherein at least a portion of the cable is configured to be coiled within the cable housing and can further be uncoiled from the cable housing when an additional length of cable is needed to extend from the cable housing to the second location.

10. The cable routing system of claim 9, wherein the cable housing is secured below the first row of seats.

11. The cable routing system of claim 9, wherein the cable is retractable into the cable housing.

12. The cable routing system of claim 9, wherein the cable housing contains a reel inside, the reel being rotatable to reduce or increase the length of the cable extending from the cable housing.

13. The cable routing system of claim 9, wherein the cable comprises data conductors and electrical conductors.

14. The cable routing system of claim 9, wherein the second location is a second row of seats.

15. The cable routing system of claim 9, wherein the cable is mounted in the floor of the aircraft.

16. The cable routing system of claim 9, wherein the cable is mounted in a sidewall of the aircraft and adjacent to the first row of seats.

17. A method of providing a cable between a plurality of rows of seats in a passenger vehicle, the method comprising:
coupling a cable housing to a first row of seats;
coiling at least a portion of a cable inside the cable housing;
connecting one end of the cable extending from the cable housing to a second location.

18. The method of claim 17, wherein the second location is a second row of seats.

19. The method of claim 17, wherein the cable housing is a retractable cable housing.

20. The method of claim 17, further comprising the step of extending at least a portion of the cable from the cable housing in order to accommodate the second location moving farther from the first row of seats.

21. The method of claim 17, wherein the cable is mounted below the first row of seats.

22. The method of claim 17, wherein the cable comprises data conductors and electrical conductors.

23. The method of claim 17, wherein the cable is mounted in the floor of the passenger vehicle.

24. The method of claim 17, wherein the cable is mounted in a sidewall of the passenger vehicle and adjacent to the first row of seats.
